(19) United States
(12) Patent Application Publication
(10) Pub. No.: US 2017/0054509 A1
(43) Pub. Date: Feb. 23, 2017

(54) Digital-to-Analog Optical Modulator Electrical Crosstalk Reduction

(71) Applicant: Huawei Technologies Co., Ltd., Shenzhen (CN)

(72) Inventor: Dominic John Goodwill, Ottawa (CA)

(21) Appl. No.: 14/832,902

(22) Filed: Aug. 21, 2015

(51) Int. Cl. H04B 10/516

(52) U.S. Cl. CPC H04B 10/516

(57) ABSTRACT

A digital-to-analog optical modulator including a first waveguide arm configured to receive a light at a first end and to output a modulated light at a second end, and a first plurality of phase shifter segments, two segments from the first plurality of phase shifter segments having the same length and optically coupled to the first waveguide arm configured to generate the modulated light in response to a digital electrical drive signal. A digital-to-analog optical modulator including a first waveguide arm comprising a first end and a second end, a first plurality of phase shifter segments optically coupled to the first waveguide arm, at least two of the first plurality of phase shifter segments are the same length, and a second waveguide arm optically coupled to the first waveguide arm at the first end and the second end.

### BACKGROUND

In a digital-to-analog optical modulator for a radio frequency (RF) over fiber application, the desired RF analog waveform is synthesized as a sequence of electronic digital words. Each digital word in the sequence is applied as an electrical drive signal to phase shifter segments of a multi-bit-driven digital-to-analog optical modulator. Applying an electrical drive signal to a phase shifter segment produces a change in a phase of a light that is passing through the phase shifter. An analog optical waveform is synthesized at the output of the digital-to-analog optical modulator. Examples of digital-to-analog optical modulators include, but are not limited to, a multi-segment Mach-Zehnder interferometer modulator and a multi-segment electro-absorption modulator.

Existing optical modulators use a power-of-two length reduction relationship between the phase shifter segments where each subsequent phase shifter segment is half the length of the previous phase shifter segment from the most significant bit (MSB) to the least significant bit (LSB). For example, the MSB phase shifter segment is 128 times longer than the LSB phase shifter segment in an eight-bit digital-to-analog optical modulator. The LSB is the bit position in a binary number with the lowest value. The MSB is the bit position in a binary number with the greatest value. Existing digital-to-analog optical modulators are focused on the linearity of digital-to-analog conversions and the optimization of the driving voltage. These optical modulators apply the same driving voltage to all of the phase shifter segments.

Electrical crosstalk is the voltage induced on a victim phase shifter segment due to a change of voltage on an aggressor phase shifter segment. The electrical crosstalk acts on the victim phase shifter segment to produce a parasitic optical phase change. The length of the victim phase shifter segment determines the size of the parasitic optical phase change. In essence, the length of the victim phase shifter amplifies the electrical crosstalk from the aggressor phase shifter segment. As a result, the worst case is the electrical crosstalk from the LSB phase shifter segment to the MSB phase shifter segment, because the MSB phase shifter segment is very long. Electrical crosstalk reduces the number of bits that can be resolved, known as the effective number of bits (ENOB). As the baud rate of higher-order modulation increases, less significant bits are swamped by electrical crosstalk and the penalty due to electrical crosstalk in the transmitter becomes more important. It is desirable for a modulator to support high-order modulation while reducing the effects of electrical crosstalk.

### SUMMARY

In one embodiment, the disclosure includes a digital-to-analog optical modulator comprising a first waveguide arm configured to receive a light at a first end and to output a modulated light at a second end, and a first plurality of phase shifter segments, two segments from the first plurality of phase shifter segments having the same length and optically coupled to the first waveguide arm configured to generate the modulated light in response to a digital electrical drive signal.

In another embodiment, the disclosure includes a digital-to-analog optical modulator comprising a first waveguide arm comprising a first end and a second end, a first plurality of phase shifter segments optically coupled to the first waveguide arm, at least two of the first plurality of phase shifter segments are the same length, and a second waveguide arm optically coupled to the first waveguide arm at the first end and the second end.

In yet another embodiment, the disclosure includes a light modulation method comprising receiving a light, receiving a first digital electrical drive signal at a first phase shifter segment and a second digital electrical drive signal at a second phase shifter segment, the first digital electrical drive signal and the second digital electrical drive signal are different voltage levels, and the first phase shifter segment and the second phase shifter segment are the same length, and modulating the light based on the digital electrical drive signal.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an optical interconnect.

FIG. 2 is a schematic diagram of an embodiment of a digital-to-analog optical modulator.

FIG. 3 is a schematic diagram of an embodiment of a digital-to-analog optical modulator with a single driving arm.

FIG. 4 is a schematic diagram of an embodiment of a digital-to-analog optical modulator with dual driving arms.

FIG. 5 is a flowchart of an embodiment of an optical modulation method for a digital-to-analog optical modulator.

FIG. 6 is a flowchart of an embodiment of a method for manufacturing a digital-to-optical optical modulator.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for a digital-to-analog optical modulator and for digital-to-analog optical modulation. In an embodiment, a digital-to-analog optical modulator is configured to reduce the drive voltage that is applied to LSB phase shifter segments or to increase the length of the LSB phase shifter segments. For example, in a conventional 4-bit optical modulator the LSB phase shifter segment is

$${\frac{1}{8} }^{th}$$

of the length of the MSB phase shifter segment, but in our optical modulator the length of the LSB phase shifter segment may be 20 times longer than the length of the LSB phase shifter segment in the convention optical modulator. Further, the LSB phase shifter segment also may be configured to use

$${\frac{1}{20} }^{th}$$

of the drive voltage that is applied to the MSB phase shifter segment. Reducing the drive voltage that is applied to the LSB phase shifter segments and increasing the length of the LSB phase shifter segments reduces the amount of electrical crosstalk that is experienced by MSB phase shifter segments. In particular, the electrical crosstalk from the LSB phase shifter segments to the MSB phase shifter segments is reduced. The LSB phase shifter segments have a short length and do not make up a significant contribution to the overall length of a digital-to-analog optical modulator. Thus, increasing the length of the LSB phase shifter segments incurs a minimal increase in the overall digital-to-analog optical modulator size.

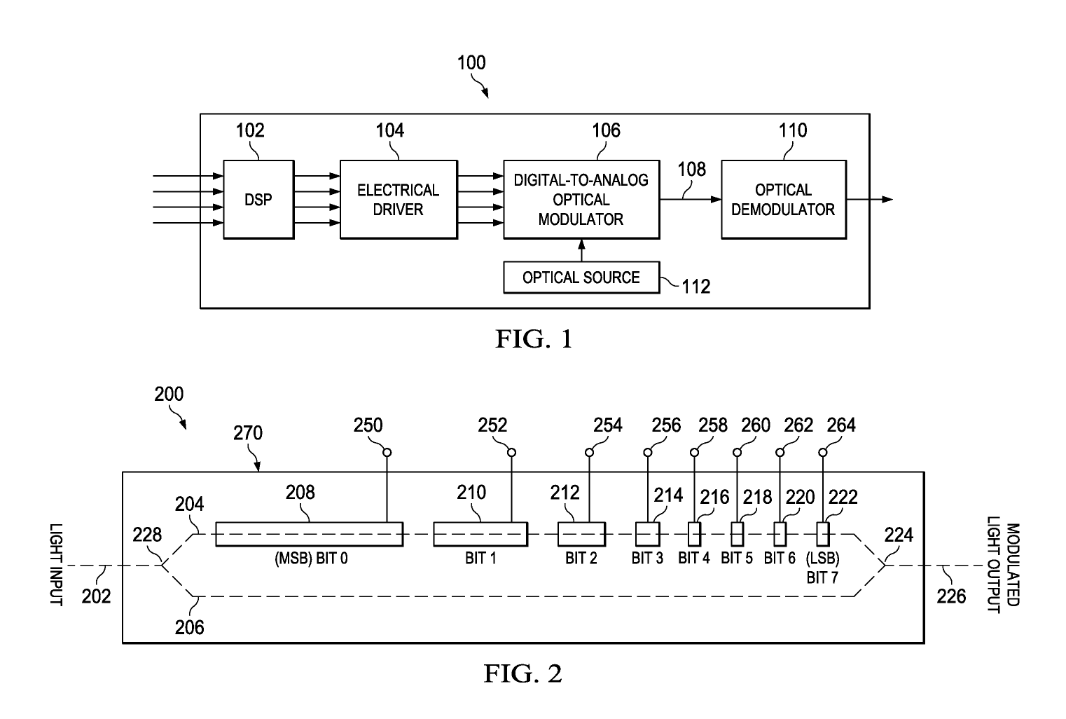

FIG. 1 is a schematic diagram of an embodiment of an optical interconnect 100. Optical interconnect 100 is configured to receive digital electrical signals, to convert the digital electrical signals to an analog optical signal, to convert the analog optical signal to an analog electrical signal, and to output the analog electrical signal. Examples of applications for optical interconnect 100 include, but are not limited to, wireless and mobile communication network tower applications, antenna remoting applications, and cable television (CATV) head-ends. Optical interconnect 100 comprises digital signal processor (DSP) 102, electrical driver 104, digital-to-analog optical modulator 106, and optical demodulator 110. Optical interconnect 100 may be configured as shown or in any other suitable configuration as would be appreciated by one of ordinary skill in the art upon viewing this disclosure.

DSP 102 is configured to receive one or more digital signals, to process the digital signals, and to output the processed digital signals. For example, parallel digital data may be digital words. Electrical driver 104 is configured to receive the parallel digital data and to output parallel digital electrical drive signals. Parallel digital data may have the same voltage swing for each bit. For example, the parallel digital data may have a low voltage swing around 0.8 volts. The digital electrical drive signals may have different voltage swings for each bit. The digital electrical drive signals may be at a different voltage level than the parallel digital data. The electrical driver 104 may include peaking circuits to improve the high-frequency response. Digital-to-analog optical modulator 106 is configured to receive the parallel digital electrical drive signals, to modulate a light from an optical source 112 in accordance with the parallel digital electrical drive signals, and to output the modulated light. The optical source 112 is optically coupled to the digital-to-analog optical modulator 106 and is configured to provide a light to the digital-to-analog optical modulator 106. An example of an optical source 112 includes, but is not limited to, a laser. Digital-to-analog optical modulator 106 is a digitally driven optical modulator that outputs an analog optical signal as modulated light. The modulated light may be communicated using an optical link 108 (e.g., an optical fiber). Examples of a digital-to-analog optical modulator 106 may include, but are not limited to, a multi-segment Mach-Zehnder interferometer modulator and a multi-segment electro-absorption modulator. Digital-to-analog optical modulator 106 is configured to implement any suitable modulation scheme as would be appreciated by one of ordinary skill in the art upon viewing this disclosure. For example, digital-to-analog optical modulator 106 is configured to implement modulation schemes including, but not limited to, radio-frequency analog modulation over an optical carrier, where the radio-frequency is as used between a cell tower and a handset such as in 2G, 3G, 4G, 4G-LTE, and 5G wireless networks. The DSP 102 may represent the analog signal using delta-sigma modulation, pulse-width modulation, or any other suitable digital representation of an analog signal. Optical demodulator 110 is configured to receive the modulated light, to demodulate the modulated light, and to output an analog electrical signal.

FIG. 2 is a schematic diagram of an embodiment of a digital-to-analog optical modulator 200, which has the form of a Mach-Zehnder interferometric modulator. Digital-to-analog optical modulator 200 may be configured similarly to digital-to-analog optical modulator 106 in FIG. 1. Digital-to-analog optical modulator 200 is an eight-bit digital-to-analog optical modulator. Digital-to-analog optical modulator 200 is configured to receive light and digital electrical drive signals, to modulate the light in accordance with the digital electrical drive signals, and to output an analog optical signal as a modulated light. Digital-to-analog optical modulator 200 comprises a substrate (e.g., a silicon substrate) 270 that comprises phase shifter segments 208-222, input waveguide 202, first waveguide arm 204, second waveguide arm 206, and output waveguide 226. Digital-to-analog optical modulator 200 may be configured as shown or may be configured in any other suitable manner.

Input waveguide 202 is optically coupled, for example, via an optical splitter (not shown), to first waveguide arm 204 and second waveguide arm 206 at a first end 228 of the first waveguide arm 204 and the second waveguide arm 206. In an embodiment, the first waveguide arm 204 and the second waveguide arm 206 are substantially parallel with each other. Input waveguide 202 is configured to guide light (e.g., continuous wave light) from a light source to the first waveguide arm 204 and the second waveguide arm 206. The light source may be configured similarly to optical source 112 in FIG. 1. For example, the light source may be a laser. Output waveguide 226 is optically coupled, for example, via an optical combiner (not shown), to first waveguide arm 204 and second waveguide arm 206 at a second end 224 of the first waveguide arm 204 and the second waveguide arm 206. Output waveguide 226 is configured to guide and output modulated light, for example, to an optical fiber.

First waveguide arm 204 is referred to as a driving arm and comprises phase shifter segments 208-222. Second waveguide arm 206 is referred to as an idle arm and does not comprise phase shifter segments. Phase shifter segments 208-222 are electro-optically coupled to the first waveguide arm 204. Phase shifter segments 208-222 are configured to receive digital electrical drive signals at electrodes (e.g., electrical contacts) 250-264 from an electrical driver and to modulate light in accordance with the digital electrical drive signals. For example, phase shifter segments 208-222 are configured to change a refractive index of a portion of the first waveguide arm 204 in response to the digital electrical drive signal. Changing the refractive index of the first waveguide arm 204 changes the phase of the light being transmitted within the first waveguide arm 204, which by means of the optical combiner may cause a change in the optical power or optical phase of the modulated light output in the output waveguide 226.

Phase shifter segment 208 is the MSB phase shifter segment and phase shifter segment 222 is the LSB phase shifter segment. Phase shifter segments 208-222 are configured such that the lengths of the MSB phase shifter segment 208 and one or more subsequent phase shifter segments (e.g., phase shifter segments 210-214) have a power-of-two length reduction relationship where each subsequent phase shifter segment is half the length of the previous phase shifter segment and the lengths of the LSB phase shifter segment 222 and one or more adjacent phase shifter segments (e.g., phase shifter segments 216-220) do not have a power-of-two length reduction relationship. The MSB phase shifter segment 208 and the one or more subsequent phase shifter segments that have a power-of-two length reduction relationship may be generally referred to as MSB phase shifter segments. The LSS phase shifter segment 222 and the one or more adjacent phase shifter segments that do not have a power-of-two length reduction relationship may be generally referred to as LSB phase shifter segments. Two or more of the LSB phase shifter segments are the same length. The phase shifter segments 208-222 may be mapped to bit locations in a bit string. If a represents a bit location that maps to a phase shifter segment, then the MSB may be identified as a=0 and the LSB may be identified as a=7 for an 8-bit modulator.

The phase shifter segments 208-222 may be configured with any suitable lengths such that the lengths of the LSB phase shifter segments do not have a power-of-two length reduction relationship. As an example, phase shifter segments 208-222 are configured such that phase shifter segments for bits a=0-3 have a length of

$${L}_{a} = {( \frac{1}{2} )}^{a} {L}_{0} ,$$

and phase shifter segments for bits a=4-7 have a length of

$${L}_{a} = {( \frac{1}{2} )}^{4} {L}_{0} ,$$

where L₀ is the length of the MSB phase-shifter. L₀ can be determined in accordance with the desired amplitude of the electrical drive signals and the strength of the electrical-to-optical effects in the phase-shifter which is depends on the physical parameters of the phase shifter segment. Typical values of L₀ are in the range of 100 micrometers (μm) to 5 millimeters (mm). As such, the phase shifter segment for bit 0 has a length of L₀, the phase shifter segment for bit 1 has a length of

$$\frac{1}{2} {L}_{0} ,$$

the phase shifter segment for bit 2 has a length of

$$\frac{1}{4} {L}_{0} ,$$

the phase shifter segment for bit 3 has a length of

$$\frac{1}{8} {L}_{0} ,$$

and the phase shifter segments for bits 4-7 have a length of

$$\frac{1}{16} {L}_{0} .$$

Further, phase shifter segments 208-222 are configured such that MSB phase shifter segments receive the same digital electrical drive voltage and the LSB phase shifter segments do not receive the same digital electrical drive voltage as the MSB phase shifter segments. In an embodiment, LSB phase shifter segments receive a power-of-two digital electrical drive source voltage reduction relationship where each subsequent phase shifter segment receives half the digital electrical drive voltage of the previous phase shifter segment. For example, phase shifter segments 208-222 are configured such that the phase shifter segments for bits a=0-3 receive a digital electrical drive voltage of Vₒ volts and the phase shifter segments for bits a=4-7 receive a digital electrical drive voltage of

$${V}_{a} = {{V}_{o} ( \frac{1}{2} )}^{a - 3}$$

volts. As such, the phase shifter segments for bits 0-3 receive a digital electrical drive voltage of Vₒ volts, the phase shifter segment for bit 4 receives a digital electrical drive voltage of

$$\frac{{V}_{o}}{2}$$

volts, the phase shifter segment for bit 5 receives a digital electrical drive voltage of

$$\frac{{V}_{o}}{4}$$

volts, the phase shifter segment for bit 6 receives a digital electrical drive voltage of

$$\frac{{V}_{o}}{8}$$

volts, and the phase shifter segment for bit 7 receives a digital electrical drive voltage of

$$\frac{{V}_{o}}{16}$$

volts. The phase shifter segments 208-222 may be configured to receive any suitable digital electrical drive voltage. In such a configuration where two or more of the LSB phase shifter segments have the same length and where different digital electrical drive voltage levels are applied to at least some of the phase shifter segments 208-222, digital-to-analog optical modulator 200 can reduce the effects of electrical crosstalk and can generate an actual phase shift difference that is close to a theoretical phase shift difference.

A phase shift that is induced by a phase shifter segment for bit a can be expressed as:

φₐ=KVₐSₐLₐ

where K is a phase shift segment constant which depends on physical parameters of the phase shifter segments, Vₐ is the digital electrical drive voltage for the phase shifter segment for bit a, Sₐ is a digital electrical drive signal on the phase shifter segment for bit a, and Lₐ is the length of the phase shifter segment for bit a. The digital electrical drive voltage has a voltage of Vₐ for a bit value of one and a voltage of zero for a bit value of zero. The phase shift on a phase shifter segment including electrical crosstalk from another phase shifter segment at bit b can be expressed as:

$${ϕ}_{a} = K ( {V}_{a} {S}_{a} {L}_{a} + {\sum }_{b \neq a} {X}_{ba} {V}_{b} {S}_{b} {L}_{b} ) ,$$

and the total phase shift can be expressed as:

$${ϕ}_{total} = K ( {\sum }_{a} ( {V}_{a} {S}_{a} {L}_{a} + {\sum }_{b \neq a} {X}_{ba} {V}_{b} {S}_{b} {L}_{b} ) )$$

where X_{ba} is the electrical crosstalk between the phase shifter segment at bit b and the phase shifter segment at bit a, V_{b} is the digital electrical drive voltage for the phase shifter segment for bit b, S_{b} is a digital electrical drive signal on the phase shifter segment of bit b, and L_{b} is the length of the phase shifter segment for bit b.

As an example, digital-to-analog optical modulator 200 transitions from a first driving pattern of 10000000 to a second driving pattern of 10000001. The theoretical phase shift difference is

$$\frac{{ϕ}_{max}}{256} .$$

The actual phase shift difference for digital-to-analog optical modulator 200 is:

$${ϕ}_{max} * ( ( \frac{1}{16} ) ( \frac{1}{30} ) ( \frac{128}{256} ) + \frac{1}{256} ) ,$$

which can be rewritten as:

$$1.27 * ( \frac{{ϕ}_{max}}{256} ) .$$

The actual phase shift difference for digital-to-analog optical modulator 200 is about 1.27 times larger than the theoretical phase shift difference. The actual phase shift difference therefore is close to the theoretical phase shift difference and is close to the magnitude of the LSB. In this example, the desired number of bits of the 8-bit modulator is 8, and the effective number of bits (ENOB) is log₂ (2⁸/1.27)=7.6 bits which is close to the desired number of bits. Therefore, the effects of electrical crosstalk between the MSB phase shifter segments and the LSB phase shifter segments are significantly reduced compared to existing optical modulators.

Implementations of digital-to-analog optical modulator 200 may include, but are not limited to, a Mach-Zehnder silicon optical modulator, a Mach-Zehnder modulator using materials exhibiting the electro-optic pockels effect (e.g., lithium niobate), a Mach-Zehnder modulator using group III-IV semiconductors (e.g., indium phosphide and gallium arsenide), a Mach-Zehnder modulator using silicon-germanium, an electro-absorption using group III-IV semiconductors, an electro-absorption modulator using silicon-germanium, and a modulator comprising a push-pull electrode arrangement comprising two driven arms that are driven in opposite polarities.

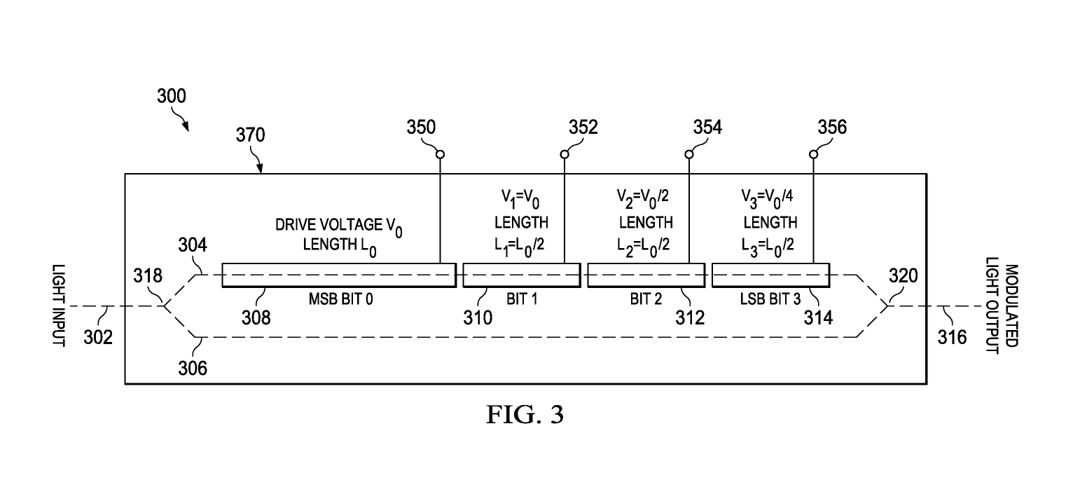

FIG. 3 is a schematic diagram of an embodiment of a digital-to-analog optical modulator 300 with a single driving arm. Digital-to-analog optical modulator 300 may be configured similarly to digital-to-analog optical modulator 106 in FIG. 1. Digital-to-analog optical modulator 300 is a four-bit digital-to-analog optical modulator. Digital-to-analog optical modulator 300 is configured to receive light and digital electrical drive signals, to modulate the light in accordance with the digital electrical drive signals, and to output an analog optical signal as a modulated light. Digital-to-analog optical modulator 300 comprises a substrate 370 that comprises phase shifter segments 308-314, input waveguide 302, first waveguide arm 304, second waveguide arm 306, and output waveguide 316. Digital-to-analog optical modulator 300 may be configured as shown or may be configured in any other suitable manner.

Input waveguide 302 is optically coupled, for example, via an optical splitter (not shown), to first waveguide arm 304 and second waveguide arm 306 at a first end 318 of the first waveguide arm 304 and the second waveguide arm 306. In an embodiment, the first waveguide arm 304 and the second waveguide arm 306 are substantially parallel with each other. Input waveguide 302 is configured to guide light from an optical source to the first waveguide arm 304 and the second waveguide arm 306. Output waveguide 316 is optically coupled, for example, via an optical combiner (not shown), to first waveguide arm 304 and second waveguide arm 306 at a second end 320 of the first waveguide arm 304 and the second waveguide arm 306. Output waveguide 316 is configured to guide and output modulated light, for example, to an optical fiber. First waveguide arm 304 is referred to as a driving arm and second waveguide arm 306 is referred to as an idle arm.

Phase shifter segments 308-314 are electro-optically coupled to the first waveguide arm 304. Phase shifter segments 308-314 are configured to receive digital electrical drive signals at electrodes 350-356 from an electrical driver and to modulate light in accordance with the digital electrical drive signals. Phase shifter segment 308 is the MSB phase shifter segment and phase shifter segment 314 is the LSB phase shifter segment. Phase shifter segments 308-314 are configured such that two or more of the LSB phase shifter segments are the same length. Further, phase shifter segments 308-314 are configured such that different digital electrical drive voltage levels are applied to at least some of the phase shifter segments 308-314. For example, phase shifter segment 308 is configured with a length of Lₒ and to receive a digital electrical drive signal voltage of Vₒ volts at electrode 350. Phase shifter segment 310 is configured with a length of

$$\frac{Lo}{2}$$

and to receive a digital electrical drive signal voltage of Vₒ volts at electrode 352. Phase shifter segment 312 is configured with a length of

$$\frac{Lo}{2}$$

and to receive a digital electrical drive signal voltage of

$$\frac{Vo}{2}$$

volts at electrode 354. Phase shifter segment 314 is configured with a length of

$$\frac{Lo}{2}$$

and to receive a digital electrical drive signal voltage of

$$\frac{Vo}{4}$$

volts at electrode 356. The phase shifter segments 308-314 may be configured with any suitable lengths. Further, the phase shifter segments 308-314 may be configured to receive any suitable digital electrical drive voltages. Second waveguide arm 306 does not comprise phase shifter segments and is not configured to modulate light. Second waveguide arm 306 is configured to guide light from the input waveguide 302 to the output waveguide 316.

In such a configuration where two or more of the LSB phase shifter segments are the same length and where different digital electrical drive voltage levels are applied to at least some of the phase shifter segments 308-314, digital-to-analog optical modulator 300 can reduce the effects of electrical crosstalk. The actual phase shift difference of digital-to-analog optical modulator 300 is close to the theoretical phase shift difference and is close to the magnitude of the LSB. The effects of electrical crosstalk between the MSB phase shifter segments and the LSB phase shifter segments are significantly reduced compared to existing optical modulators.

Implementations of digital-to-analog optical modulator 300 may include, but are not limited to, a Mach-Zehnder silicon optical modulator, a Mach-Zehnder modulator using materials exhibiting the electro-optic pockels effect (e.g., lithium niobate), a Mach-Zehnder modulator using group III-IV semiconductors (e.g., indium phosphide and gallium arsenide), a Mach-Zehnder modulator using silicon-germanium, an electro-absorption modulator using group III-IV semiconductors, an electro-absorption modulator using silicon-germanium, and a modulator comprising a push-pull electrode arrangement comprising two driven arms that are driven in opposite polarities.

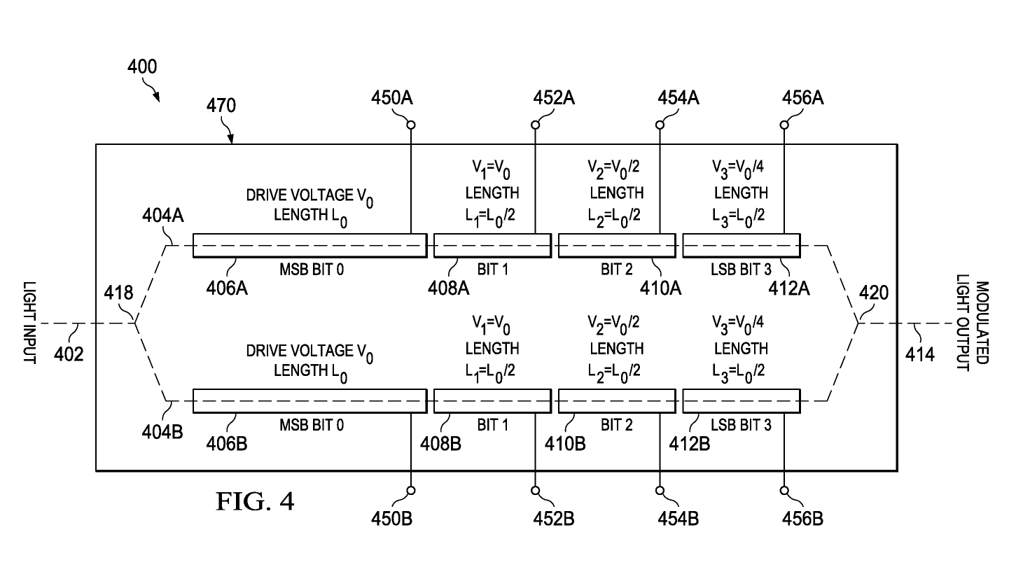

FIG. 4 is a schematic diagram of another embodiment of a digital-to-analog optical modulator 400 with dual driving arms. A digital-to-analog modulator with dual driving arms may provide less optical loss than a digital-to-analog modulator with a single driving arm. Digital-to-analog optical modulator 400 may be configured similarly to digital-to-analog optical modulator 106 in FIG. 1. Digital-to-analog optical modulator 400 is a four-bit digital-to-analog optical modulator. Digital-to-analog optical modulator 400 is configured to receive light and digital electrical drive signals, to modulate the light in accordance with the digital electrical drive signals, and to output an analog optical signal as a modulated light. Digital-to-analog optical modulator 400 comprises a substrate 470 that comprises an input waveguide 402, phase shifter segments 406A-412A, a first waveguide arm 404A, phase shifter segments 406B-412B, a second waveguide arm 404B, and an output waveguide 414. Digital-to-analog optical modulator 400 may be configured as shown or may be configured in any other suitable manner.

Input waveguide 402 is optically coupled, for example, via an optical splitter (not shown), to first waveguide arm 404A and second waveguide arm 404B at a first end 418 of first waveguide arm 404A and second waveguide arm 404B. In an embodiment, the first waveguide arm 404A and the second waveguide arm 404B are substantially parallel with each other. Output waveguide 414 is optically coupled, for example, via an optical combiner (not shown), to first waveguide arm 404A and second waveguide arm 404B at a second end 420 of the first waveguide arm 404A and the second waveguide arm 404B. First waveguide arm 404A and second waveguide arm 404B are both configured as driving arms.

Phase shifter segments 406A-412A are electro-optically coupled to the first waveguide arm 404A. Phase shifter segments 406A-412A are configured to receive digital electrical drive signals at electrodes 450A-456A from an electrical driver and to modulate the light in accordance with the digital electrical drive signals. Phase shifter segment 406A is the MSB phase shifter segment and phase shifter segment 412A is the LSB phase shifter segment. Phase shifter segments 406A-412A are configured such that two or more of the LSB phase shifter segments are the same length. Further, phase shifter segments 406A-412A are configured such that different digital electrical drive voltage levels are applied to at least some of the phase shifter segments 406A-412A. For example, phase shifter segment 406A is configured with a length of Lₒ and to receive a digital electrical drive signal voltage of Vₒ volts at electrode 450A. Phase shifter segment 408A is configured with a length of

$$\frac{Lo}{2}$$

and to receive a digital electrical drive signal voltage of Vₒ volts at electrode 452A. Phase shifter segment 410A is configured with a length of

$$\frac{Lo}{2}$$

and to receive a digital electrical drive signal voltage of

$$\frac{Vo}{2}$$

volts at electrode 454A. Phase shifter segment 412A is configured with a length of

$$\frac{Lo}{2}$$

and to receive a digital electrical drive signal voltage of

$$\frac{Vo}{4}$$

volts at electrode 456A. The phase shifter segments 406A-412A may be configured with any suitable lengths. Further, the phase shifter segments 406A-412A may be configured to receive any suitable digital electrical drive voltages.

Second waveguide arm 404B is configured to mirror first waveguide arm 404A. For example, phase shifter segments 406B-412B are electro-optically coupled to the second waveguide arm 304B. Phase shifter segments 406B-412B are configured to receive digital electrical drive signals at electrodes 450B-456B from an electrical driver and to modulate the light in accordance with the drive signals. Phase shifter segment 406B is the MSB phase shifter segment and phase shifter segment 412B is the LSB phase shifter segment. Phase shifter segments 406B-412B are configured such that two or more of the LSB phase shifter segments are the same length. Further, phase shifter segments 406B-412B are configured such that different digital electrical drive voltage levels are applied to at least some of the phase shifter segments 406B-412B. For example, phase shifter segment 406B is configured with a length of Lₒ and to receive a digital electrical drive signal voltage of Vₒ volts at electrode 450B. Phase shifter segment 408B is configured with a length of

$$\frac{Lo}{2}$$

and to receive a digital electrical drive signal voltage of Vₒ volts at electrode 452B. Phase shifter segment 410B is configured with a length of

$$\frac{Lo}{2}$$

and to receive a digital electrical drive signal voltage of

$$\frac{Vo}{2}$$

volts at electrode 454B. Phase shifter segment 412B is configured with a length of

$$\frac{Lo}{2}$$

and to receive a digital electrical drive signal voltage of

$$\frac{Vo}{4}$$

volts at electrode 456B. The phase shifter segments 406B-412B may be configured with any suitable lengths. Further, the phase shifter segments 406B-412B may be configured to receive any suitable digital electrical drive voltage. In an embodiment, the phase shifter segments 406B-412B may be configured to receive digital electrical drive voltages that are equal in amplitude but opposite in polarity from the digital electrical drive signals that are received at phase shifter segments 406A-412A. In another embodiment, the phase shifter segments 406B-412B may have different lengths or be driven with different driving voltages than corresponding respective phase shifter segments 406A-412A, and the digital electrical drive signals may be different between the first waveguide arm 404A and the second waveguide arm 404B, so that the effective number of bits is larger than the number of segments in one of the arms, such that a high order of analog modulation is achieved. In a further embodiment, the number of phase shifter segments in second waveguide arm 404B may be different than the number of phase shifter segments in first waveguide arm 404A.

In such a configuration where two or more of the LSB phase shifter segments on the same driving arm have the same phase shift segment length and where different digital electrical drive voltage levels are applied to at least some of the phase shifter segments 406A-412A and 406B-412B, digital-to-analog optical modulator 400 can reduce the effects of electrical crosstalk. The actual phase shift difference of digital-to-analog optical modulator 400 is close to the theoretical phase shift difference and is close to the magnitude of the LSB. The effects of electrical crosstalk between the MSB phase shifter segments and the LSB phase shifter segments are significantly reduced compared to existing optical modulators. Implementations of digital-to-analog optical modulator 400 may include, but are not limited to, a Mach-Zehnder silicon optical modulator, a Mach-Zehnder modulator using materials exhibiting the electro-optic pockels effect (e.g., lithium niobate), a Mach-Zehnder modulator using group III-IV semiconductors (e.g., indium phosphide and gallium arsenide), a Mach-Zehnder modulator using silicon-germanium, an electro-absorption using group III-IV semiconductors, an electro-absorption modulator using silicon-germanium, and a modulator comprising a push-pull electrode arrangement comprising two driven arms that are driven in opposite polarities.

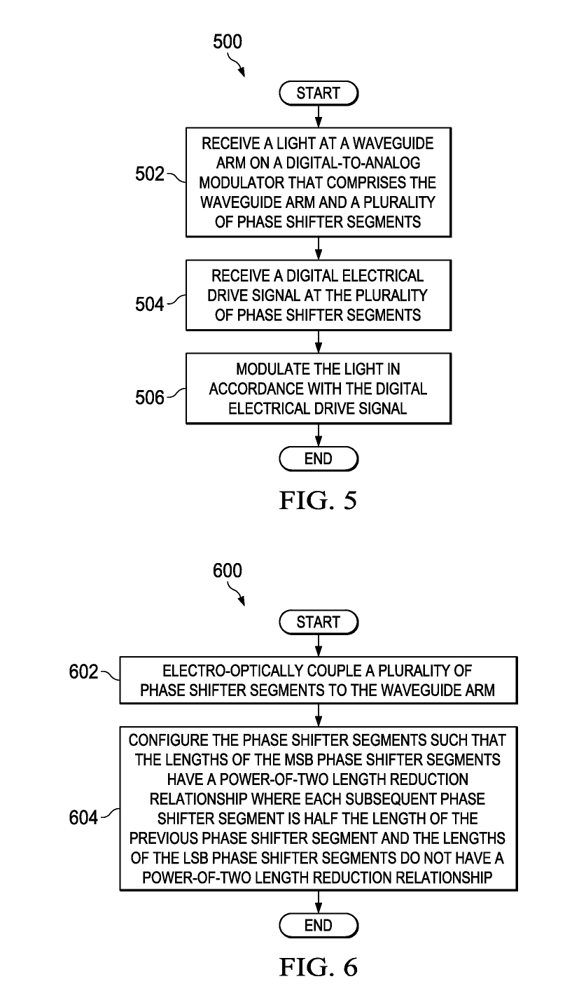

FIG. 5 is a flowchart of an embodiment of an optical modulation method 500 for a digital-to-analog optical modulator. Method 500 is implemented in an optical interconnect (e.g., optical interconnect 100 in FIG. 1) to generate an analog optical signal as a modulated light. A digital-to-analog optical modulator is obtained that comprises a waveguide arm and a plurality of phase shifter segments. The waveguide arm is electro-optically coupled to a plurality of phase shifter segments. In an embodiment, the digital-to-analog optical modulator is configured similarly to digital-to-analog optical modulator 200 in FIG. 2, digital-to-analog optical modulator 300 in FIG. 3, or digital-to-analog optical modulator 400 in FIG. 4. At step 502, light is received at the waveguide arm. At step 504, a digital electrical drive signal is received at the electrodes of the phase shifter segments. For example, the digital electrical drive signal is a digital word or bit string that is applied to the electrodes of the phase shifter segments. The digital electrical drive signal may be received by all of the electrodes of the phase shifter segments at substantially the same time. The digital electrical drive signal comprises two or more digital electrical drive voltage levels. For example, a first digital electrical drive voltage level is applied to LSB phase shifter segments and a second digital electrical drive voltage is applied to MSB phase shifter segments. The first digital electrical drive voltage may be a lower voltage level than the second digital electrical drive voltage level. At step 506, the light is modulated in accordance with the digital electrical drive signal. The phase shifter segments are configured to change a refractive index of the waveguide arm in response to the digital electrical drive signal. Changing the refractive index of the waveguide arm changes the phase of the optical power of the light, and thereby generates a modulated light. The modulated light is emitted from the waveguide arm and the digital-to-analog optical modulator.

FIG. 6 is a flowchart of an embodiment of a method 600 for manufacturing a digital-to-analog optical modulator such as those described above. In an embodiment, the digital-to-analog optical modulator is configured similarly to digital-to-analog optical modulator 200 in FIG. 2, digital-to-analog optical modulator 300 in FIG. 3, or digital-to-analog optical modulator 400 in FIG. 4. A substrate is obtained that comprises a waveguide arm. At step 602, a plurality of phase shifter segments are electro-optically coupled to the waveguide arm. At step 604, the phase shifter segments are configured such that the lengths of the MSB phase shifter segments use a power-of-two length reduction relationship where each subsequent phase shifter segment is half the length of the previous phase shifter segment and the lengths of the LSB phase shifter segments do not have a power-of-two length reduction relationship. Two or more of the LSB phase shifter segments are the same length. Further, the phase shifter segments are configured such that MSB phase shifter segments receive the same digital electrical drive voltage and LSB phase shifter segments do not receive the same digital electrical drive voltage. LSB phase shifter segments receive a power-of-two digital electrical drive source voltage reduction relationship where each subsequent phase shifter segment receives half the digital electrical drive voltage of the previous phase shifter segment. As such, a lower voltage level is applied to LSB phase shifter segments than the voltage level that is applied to the MSB phase shifter segments.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A digital-to-analog optical modulator comprising:
a first waveguide arm configured to receive a light at a first end and to output a modulated light at a second end; and
a first plurality of phase shifter segments, two segments from the first plurality of phase shifter segments having the same length and optically coupled to the first waveguide arm configured to generate the modulated light in response to a digital electrical drive signal.

2. The digital-to-analog optical modulator of claim 1, wherein each of the first plurality of phase shifter segments maps to a bit, and wherein the at least two of the first plurality of phase shifter segments correspond with least significant bits.

3. The digital-to-analog optical modulator of claim 1, further comprising a plurality of electrodes, wherein each of the electrodes is coupled to one of the first plurality of phase shifter segments, and wherein at least two of the electrodes are configured to receive different digital electrical drive voltage levels.

4. The digital-to-analog optical modulator of claim 1, wherein lengths of a portion of the first plurality of phase shifter segments have a power-of-two length reduction relationship.

5. The digital-to-analog optical modulator of claim 1, further comprising:
a second waveguide arm optically coupled to the first waveguide arm at the first end and the second end; and
a second plurality of phase shifter segments optically coupled to the second waveguide arm, and wherein at least two of the second plurality of phase shifter segments are the same length.

6. The digital-to-analog optical modulator of claim 5, wherein the second plurality of phase shifter segments are configured to receive different digital electrical drive voltage levels than the first plurality of phase shifter segments.

7. The digital-to-analog optical modulator of claim 5, wherein the first plurality of phase shifter segments comprises a different number of phase shifter segments than the second plurality of phase shifter segments.

8. The digital-to-analog optical modulator of claim 1, wherein the first plurality of phase shifter segments does not have a power-of-two length reduction relationship.

9. The digital-to-analog optical modulator of claim 1, wherein lengths of a first portion of the first plurality of phase shifter segments have a power-of-two length reduction relationship, and wherein lengths of a second portion of the first plurality of phase shifter segments does not have a power-of-two length reduction relationship.

10. A digital-to-analog optical modulator comprising:
a first waveguide arm comprising a first end and a second end;
a first plurality of phase shifter segments optically coupled to the first waveguide arm, at least two of the first plurality of phase shifter segments are the same length; and
a second waveguide arm optically coupled to the first waveguide arm at the first end and the second end.

11. The digital-to-analog optical modulator of claim 10, wherein each of the first phase shifter segments maps to a bit, and wherein the at least two of the first plurality of phase shifters correspond with least significant bits.

12. The digital-to-analog optical modulator of claim 10, further comprising a plurality of electrical contacts, wherein each of the electrical contacts is coupled to one of the first plurality of phase shifter segments, and wherein at least two of the electrical contacts are configured to receive different digital electrical drive voltage levels.

13. The digital-to-analog optical modulator of claim 12, wherein the different digital electrical driving voltage levels uses a power-of-two voltage reduction relationship.

14. The digital-to-analog optical modulator of claim 10, wherein lengths of the first plurality of phase shifter segments does not have a power-of-two length reduction relationship.

15. The digital-to-analog optical modulator of claim 10, wherein lengths of a first portion of the first plurality of phase shifter segments have a power-of-two length reduction relationship, and wherein lengths of a second portion of the first plurality of phase shifter segments does not have a power-of-two length reduction relationship.

16. The digital-to-analog optical modulator of claim 10, further comprising a second plurality of phase shifter segments optically coupled to the second waveguide arm, and wherein at least two of the second plurality of phase shifter segments are the same length.

17. A light modulation method comprising:
receiving a light;
receiving a first digital electrical drive signal at a first phase shifter segment and a second digital electrical drive signal at a second phase shifter segment, the first digital electrical drive signal and the second digital electrical drive signal are different voltage levels, and the first phase shifter segment and the second phase shifter segment are the same length; and
modulating the light based on the digital electrical drive signal.

18. The method of claim 17, wherein the first digital electrical drive signal and the second digital electrical drive signal have a power-of-two voltage reduction relationship.

19. The method of claim 17, wherein the first phase shifter segment and the second phase shifter segment each maps to least significant bits.

20. The method of claim 17, wherein the first digital electrical drive signal and the second digital electrical drive signal are received at the same time.
